(19) United States
(12) Patent Application Publication
(10) Pub. No.: US 2010/0082538 A1
(43) Pub. Date: Apr. 1, 2010

(54) ISOLATED REPLICATION OF SHARED OBJECTS

(76) Inventors: Heiko Rentsch, Dresden (DE); Christian Gunsel, Dresden (DE)

Correspondence Address: SEED INTELLECTUAL PROPERTY LAW GROUP PLLC, 701 FIFTH AVE, SUITE 5400, SEATTLE, WA, 98104, US

(21) Appl. No.: 12/240,837

(22) Filed: Sep. 29, 2008

(51) Int. Cl. G06F 17/30

(52) U.S. Cl. 707/616; 707/E17.044; 707/E17.001

(57) ABSTRACT

Methods, techniques, and systems for providing replication mechanisms in distributed computer environments executing database applications are provided. The mechanisms provide for replication of application objects between clients in the distributed computer environment as well as between an application server and a database server in the distributed computer environment, wherein the copying of an object onto a target storage at a client or a server is performed not before a request on that object is initiated via the target storage. In an example embodiment, each application object has assigned a proxy object, which sits before the real object. Accordingly, the proxies take over functions of lazy loading and change tracking from real application objects. Objects which have been loaded into the target context are stored in a local object store at the respective client or server.

### TECHNICAL FIELD

The present disclosure relates to methods, techniques, and systems for providing replication in a distributed computing environment and, in particular, to methods, techniques, and systems for providing replication of application objects between client computing systems as well as between application and database server computing systems.

### BACKGROUND

When developing complex computer applications, in particular, computer applications accessed by a number of users (e.g., clients, or client applications), generally 3-tier architectures are implemented. That means that in a first tier, the data used within the computer application is centrally stored in a database (e.g., a database server). At the second tier, an application server (e.g., an application) holds the application logic, performs the application procedures and thus, provides the application services to the clients at the third tier. Typically, the application server as well as the clients (also referred to herein as client applications or client computing systems) communicate with the database server via data links. Similarly, the numerous clients accessing the application communicate with the application server via data links.

By this widely used 3-tier architecture, a distributed computer system is established. For improving reliability, tolerance, accessibility and/or performance of a computer application in such a distributed computer system, replication as a process of sharing information is often used. In this sense, replication serves as a process of sharing information so as to ensure consistency between redundant resources such as, for example, data on each of the elements of the distributed computer system, i.e., the clients, the application server, and/or the database server.

For providing replication in such distributed systems, a number of different models exist, for example, transaction replication, state machine replication, and virtual synchrony. The levels of performance vary widely depending on the model selected. For example transaction replication is considered to be the slowest, at least when one copy-serializability guarantees are desired. In contrast, virtual synchrony is considered the fastest of the three models, but the handling of failures is considered as less rigorous than, for example, in the transaction model. State machine replication again is considered to be faster than the transaction replication but much slower than virtual synchrony.

Thus, for different uses cases, various replication concepts exist which get combined with temporary storage models, such as, for example, caching concepts. These differing concepts in replication and caching share a common draw back, which is the significant differences in how the mechanisms interact with functional code, i.e., application objects. Thus, the respective interaction mechanisms have to be taken into account when developing the respective applications that are intended to use such mechanisms.

These mechanisms, are typically used within the context of database applications, in particular for enabling multi-user services. In cases in which several users operate on the same data, it is generally favorable for changes made by a particular user to only become visible (to the other users) after the update is confirmed (by the changing user), e.g., after the user presently applying changes has confirmed the storing of the updated data (i.e., that the change is to be made). This requires at least a temporary storing of the to-be-changed-data that the user is currently working with. More particularly, the data that is intended to be changed is typically stored as a copy at least for the time the user is working on that data and has not yet confirmed the update.

Not copying the data before a change becomes permanent and/or presenting other users working on the same data with unconfirmed or inconsistent data, would lead obviously to application and/or data failures. Alternatively, as long as one user is accessing a certain data, and the data is not being copied in the above described way, accessing the data would have to be blocked for the time the particular user is working on that data, obviously leading to significant losses in application performance and/or usability.

Therefore, to achieve reasonable performance, replication and caching mechanisms have been implemented within the context of database applications. To achieve this, generally it is favorable to temporarily store data close to the user (client) of the data. Therefore, in terms of optimizing performance of database application, data can be read from the database server on tier1 just once and then at least stored in a temporary data store or rather, a cache on the application server at tier2. Further, when accessing said data and working on the data, it might be favorable to transfer the data from the application server on tier2 to the client on tier3 where the data can be temporarily stored at the user interface. This provides the advantage that the network connection or rather the bandwidth between client/application server/database server is less intensively occupied by frequent data transfers.

In certain contexts, for example, depending on the application design, it may be favorable to defer loading of data from the database server until the point at which the data is actually needed. This design pattern can contribute to the efficiency of the computer applications operation.

However, while several ways of implementing this design pattern are known, each has their own advantages and disadvantages. A common drawback of all of these known implementations of the design pattern is that computer applications, or rather functional code, cannot be developed without knowledge about the implemented framework of the replication/caching/deferred loading mechanisms. That is, the developed code has to be customized as to work with a specific implementation of the respective design pattern and can not be transferred to work with another of the available design patterns. This implies increased burden for computer application developing and in particular reduces the flexibility of re-use of once developed software code and modules.

### BRIEF DESCRIPTION OF THE DRAWINGS

FIG. 1 schematically shows a distributed computer environment executing a database application.

FIG. 2 schematically shows a service-based process of synchronization between a server and a client tier.

FIG. 3 schematically shows a service-based replication mechanism in a three-tier distributed database application environment.

FIG. 4 schematically shows the states of proxies within a merge algorithm according to the example replication mechanism described herein.

FIG. 5 schematically shows the sequence performed using the merge algorithm of example embodiments for dissolving child references in a new target context.

FIG. 6 schematically shows an example sequence performed for the method of OnChildChanged using the merge algorithm of example embodiments.

FIG. 7 schematically shows an example flow diagram of the sequence of actions performed during the merge algorithm of example embodiments.

FIG. 8 schematically shows a client and server view of an initial state of an illustrative example of performing the merge algorithm according to example embodiments.

FIG. 9 schematically shows the client and server view of the initial state highlighted in FIG. 8 after calling the updating method and the changing of the proxy state to “checked-out.”

FIG. 10 schematically shows the client and server view of the temporary state achieved after calling the updating and clone methods.

FIG. 11 schematically shows the client and server view of the temporary state achieved after calling the ResolveChildren methods for comparing versions on objects in the server and client snapshot.

FIG. 12 schematically shows the client and server view of the state achieved after having performed the merge algorithm according to example embodiments on the example highlighted in FIG. 8 such that the internal state of the proxies has been transparently set to the most current versions.

FIG. 13 schematically shows an example sequence diagram of the Lazy Loading sequence in the process of remote proxy creation.

FIG. 14 schematically shows an example sequence diagram of the Read operation sequence in the process of remote proxy creation;

FIG. 15 schematically shows an example sequence diagram of the Write operation sequence in the process of remote proxy creation.

FIG. 16 schematically shows an example sequence diagram of the Create operation sequence in the process of remote proxy creation.

### DETAILED DESCRIPTION

Embodiments described herein provide enhanced computer- and network-based methods, techniques, and systems for replicating shared application objects of an application in distributed computer environment, for example, a database application, wherein application objects are replicated from a server (e.g., a server computing system) to a client (e.g., a client computing system) and a replicated application object is not transferred from the server to the client until at least a request on the data of the replicated application object is generated at the client. Example embodiments provide a replicated shared object framework. As part of this framework, an application object service is provided that handles all requests issued at the client. A proxy application object service is inserted before the application object service at the client. In addition, using the proxy application object service at the client, at least one proxy application object is generated, wherein each proxy application object is assigned to an original application object that is stored on a server, for example, in a database of the database application. In addition, example embodiments provide an object graph alternating proxy application objects and original application objects. Also, any request issued at the client on at least one original application object is re-routed via the proxy application object assigned to the at least one application object so that the proxy application object can log all changes on the at least one original application object in a transaction protocol.

In at least one example embodiment, in response to a request on the data of at least one original application object by the proxy application object via the application object service, the at least one original application object is retrieved from the database and transferred to the client.

In at least one example embodiment, the transferred original application object is stored locally at the client in a local cache and all consecutive requests on the transferred original application object are serviced from the local cache.

In at least one example embodiment, each proxy application object references solely original application objects and original application objects solely reference proxy application objects.

In at least one example embodiment, a unique version number for each replicated application object is provided, and the provided version number is changed only in response to a change in the state of the respective replicated application object.

In at least one example embodiment, all changes applied to the replicated application object are logged in a transaction protocol, the transaction protocol comprising entries of the type “modification” and comprising the actions of create, update and/or delete. The transaction protocol further comprises a reference to the modified version of the replicated application object.

In at least one example embodiment, the changes applied to a replicated application object are of a specific type, the types of changes being at least one of insertion, replacement, and/or deletion of a version of the replicated application object and object graph.

In at least one example embodiment, a method is provided for performing the actions of any of the above described techniques.

In at least one example embodiment, a computer-readable medium is provided having stored thereon contents, for example, computer-readable instructions that, when executed on a computer, are configured for performing the actions of any of the above described techniques. The computer-readable medium may be, for example, a computer-readable memory means communicatively coupled to a computer system, which stores the computer-readable instructions. In other example embodiments, the computer-readable medium may include for example, computer-readable transmission mediums, including wireless-based and wired/cable-based mediums which store and/or transmit signals containing computer-readable instructions for performing the actions of any of the above described techniques.

Other example embodiments provide a distributed computer system that executes a database application, the database application replicating shared application objects on clients and servers of the distributed computer system, wherein the application objects are replicated from a server to a client and a replicated application object is not transferred from the server to the client until at least a request on the data of the replicated application object is generated at the client computer system. The system further provides means configured for providing an application object service that handles all requests issued at the client. Further, the system provides means configured to inserting a proxy application object service before the application object service at the client. In addition, the system provides means configured for generating, using the proxy application object service at the client, at least one proxy application object, wherein each proxy application object is assigned to an original application object being stored in a database of the database application. The system also provides storage means, such as a computer-readable medium, for storing an object graph alternating proxy application objects and original application objects. Also, the system provides means for re-routing any request issued at the client on at least one original application object to the proxy application object assigned to the at least one application object such that the proxy application object can log all changes on the at least one original application object in a transaction protocol.

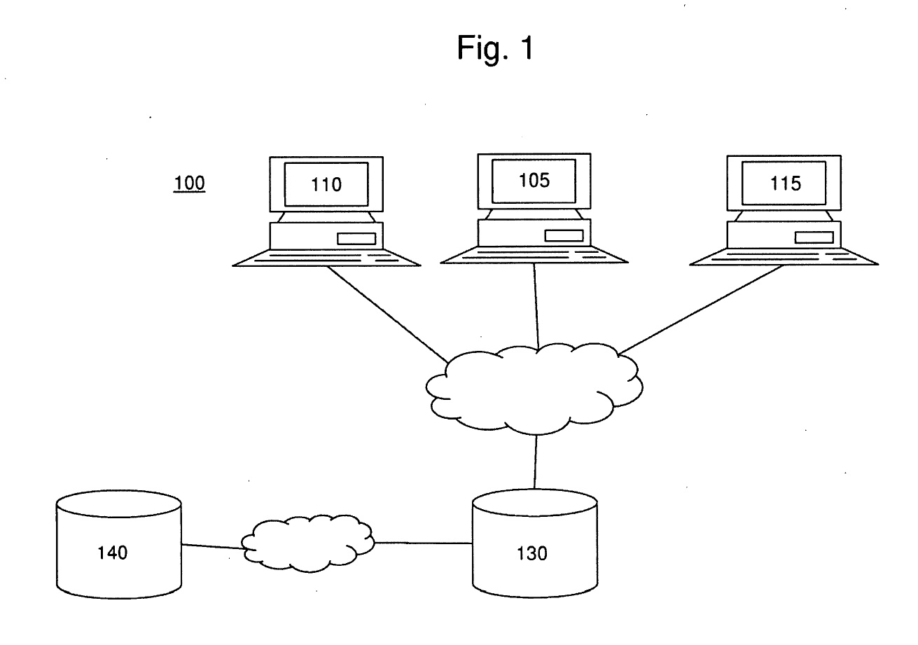

FIG. 1 schematically shows a database server 140, an application server 130 and client computers 105-115 as part of a distributed database application system 100. As illustrated in FIG. 1, these components of the distributed database application system 100 are connected via data links. Typically, these data links are implemented as network connections, for example, internet connections. However, the various implementations of these data links are applicable, in particular network connections can be used as well as alternative technical solutions for providing clients 105-115 and servers 130/140 remote access to application object and/or data stored at clients 105/115 and/or servers 130/140. More particularly, database server 140 is connected with application server 130. Further, application server 130 is connected to each of the clients 105-115. Nevertheless, it is to be noted that the number of clients 105-115, the number of application 130 and database servers 140 is rather illustrative, and any number of clients 105-115, as well as any number of data servers 140 and any number of application servers 130 may be implemented. In particular, for example, database server 140 and application server 130 in fact could be implemented on one and the same computing system. Further, in another example embodiment, application server 130 and at least one of the clients 105-115 could be implemented on one and the same computer system. Various methods of heterogeneous and homogenous computer systems may be used, and distributed in other manners.

In the example distributed computer application system 100, the database server 140 holds the data, that is, it stores application data in a database. However, storing the data in one database is only one exemplary embodiment serving illustrative purposes rather than indicating any restrictions. Therefore, alternatively, the data could, for example, be stored in a number of databases and these various databases could be stored at databases sever 140 or alternatively stored at a remote storage location as long as at least databases server 140 has access to these databases to execute or request respective database operations. The data, stored in the database of database server 140 supports the execution of the application, which is stored at the application server 130.

Clients 105-115 execute or request execution of the application at the application server 130 in order to execute the database application provided by application system 100. In order to achieve this, a request is issued from at least one of the clients 105-115 and transferred via the network connection or other data links to application server 130. In response to this request, if data stored at database server 140 is needed, application server 130 issues a request for retrieving that data, via the network connection, to database server 140.

In response to this request, database server 140 requests and retrieves the requested data from the database stored at the database server 140 and provides this data via the network connection or data link to application server 130. In response to receiving the data, either the application server 130 executes the request and provides a result to the request from computer system 105-115, for example, or the data provided from the database server 140 is provided from application server 130 through the network connection to the requesting client computer system 105-115.

In an example embodiment, the clients 105-115 and servers 130 and 140 may be implemented on general purpose or special purpose computers or computing systems. These computing systems may be implemented in software, hardware, firmware, or in some combination. One or more of them may include one or more central processing units (CPUs), input/output (I/O) devices, memory or other computer-readable media, and one or more network connections.

Also, some or all of the components may be implemented or provided in other manners, such as at least partially in firmware and/or hardware, including, but not limited to one ore more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc.

Some or all of the system components and/or data structures may also be stored as contents (e.g., as executable or other machine-readable software instructions or structured data) on a computer-readable medium such as a hard disk; a memory; a network; or a portable media article to be read by an appropriate drive or via an appropriate connection. Some or all of the system components and data structures may also be stored and/or transmitted as contents of generated data signals (e.g., by being encoded as part of a carrier wave or otherwise included as part of an analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

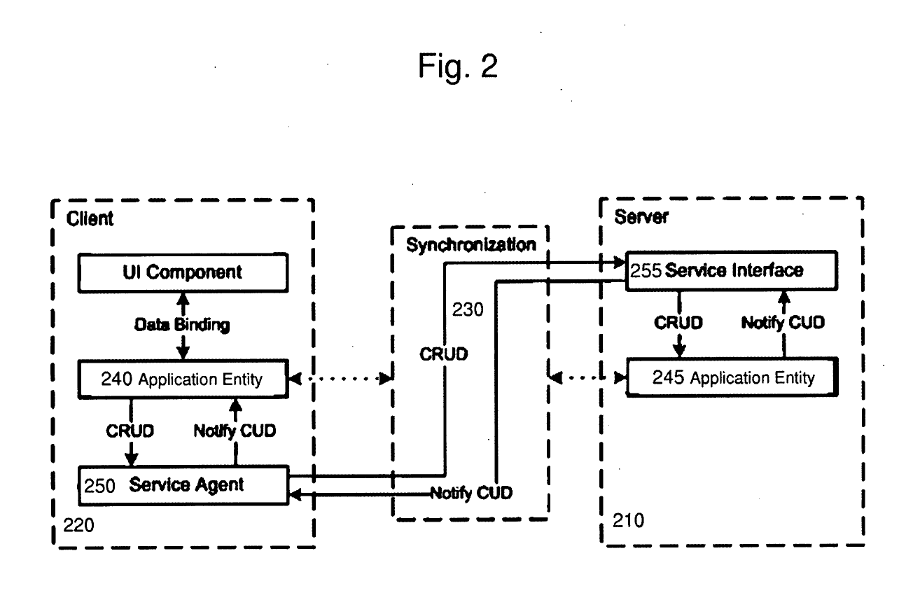

FIG. 2 schematically shows a service-based synchronization mechanism according to techniques of example embodiments that makes use of specific server implementations for providing the synchronization. In particular, FIG. 2 shows a server system 210 that is connected via a network connection indicated by the dotted arrows with client system 220.

Server system 210 represents at least one of the server systems 140/130 as described above within the context of FIG. 1. Therefore, server system 210 might serve either as a database server 140 or an application server 130. Furthermore, any number of clients, for example, the single client 220 as indicated in FIG. 2 for illustrative purposes, could be connected to servers 210. In at least one example embodiment, the synchronization or replication techniques may be further used for scaling a distributed computer application environment or database application system over numerous application servers.

As illustrated in FIG. 2, synchronization 230 between server system 210 and client 220 is performed on the level of application entities 240 and 245. The application entities 240 and 245 represent objects of a computer application. In at least one example embodiment, server system 210 stores an object graph of the computer application provided by database application system 100 as described within the context of FIG. 1. Thus, the synchronization between server 210 and client 220 is performed on the level of application objects within an object graph stored at server 210. In at least one example embodiment, computer application system 100 provides a business application, where the object graph is constructed by business objects and the synchronization is performed on the level of these business objects or business entities.

In addition, FIG. 2 shows that, in at least one example embodiment, the synchronization mechanism 230 is performed using a specific service implementation where a service interface 255 and a service agent 250 are provided that communicate from server 210 to client 220 and vice versa. In this respect, interface 255 interacts via the network connection with the service agent 250 to client 220. Therefore, accordingly, application entity 240 does not directly synchronize with application entity 245, but the synchronization is performed via services 250/255 that provide the administration of all application entities 240/245, such that preferably all application entities 240/245 can only be generated, read, and changed via these services 250/255.

Thus, accordingly, a number of service implementations can be supported, which can be defined, for example, at run time via configuration parameters, and which can also be combined with each other. By providing this service-based synchronization, location transparency, e.g., between a client 220 and server 210, is provided as well as functional transparency, in particular, in terms of remote versus database services. As illustrated in FIG. 2, the service implementation 250/255 sits before the “real” application service or object service 245/240; thus providing a proxy to each application object 240/245. Accordingly, for each application object 240/245, via specific service implementations 250/255 that sit before the real object service that provides application objects 240/245, a proxy is assigned to each of the application objects 240/245.

In that respect, the service-based implementation of the synchronization mechanism provides for building agile application modules using in-memory services as the unit of work.

Thus, the techniques provided by example embodiments can transparently be externalized, for example, as Web Service operations. In order to embrace all existing programming paradigms, languages, and platforms, the described synchronization or replication mechanisms are implemented on the level of semantics of service calls, logical routing, and data flow descriptions across the illustrated service interfaces 250/255. Accordingly, the program modules of the synchronization/replication mechanisms are encapsulated as services. In at least one example embodiment, these services are composed of other nested services in a hierarchical manner with limitless depth in service stack hierarchy.

The service implementations provide built-in native ability in terms of data integration, multi-threading of service modules, and synchronization of services 250/255. Moreover, the services provide for semantically synchronizing the execution of services 250/255 and declaration of a service module as a transaction boundary with automated commit/rollback behavior. In that sense, the service implementation provides a further level of abstraction for creating composite applications, thus significantly increasing responsiveness to change in terms of agility. Moreover, service-based synchronization/replication increases the level of unification in the integration and software component development for the respective database computer application and thus significantly reduces the complexity of integration by, for example, enabling “inside-out integration.” Furthermore, the specific service implementation 250/255 provides automated multi-threading and virtualization of the respective database computer application at the unit-of-work level.

In order to achieve the above identified effects, the specific service implementations 250/255 that are provided according to exemplary techniques implement the following principles:

(a) In-memory application entities 240 are strictly encapsulated through well-defined service interfaces 250/255 that can be externalized on-demand. By implementing this minimal unit of encapsulation, flexibility in terms of, for example, reusability within other in-memory application entities 240, as well as across other software programs, is achieved. The service interfaces 250/255 in that respect provide information hiding to achieve separation of entities across in-memory application entities 240.

(b) Service interfaces 250/255 are in-memory objects that describe a well-defined software task with well-defined input and output data structures. Service interfaces 250/255 can be assigned to one or many service groups based on shared properties. In an example embodiment, runtime properties stored on the metadata of the service interface 250/255 serve as a contract, for example, providing declarative service synchronization. Service interface 250/255 in that sense can be declared as a fully synchronized interface with the consequence that only one single instance of that service 250/255 can run at any given time. Alternatively, the service 250/255 can be synchronized based on the actual value of key inputs at runtime with the consequence that no two service instances of that service 250/255 with the same value for their key input data can run at the same time.

(c) The service agent 250 creates service requests. In at least one embodiment, the service agent 250 is a pluggable in-memory interface that abstracts the location of a service producer (e.g., the database server 210) as well as the communication protocol, used between the client 220 (“Consumer”) and database server 210 (“Producer”). It is the use of the service agent 250 which substantially provides for the further above described advantages of location transparency and virtualization. Furthermore, providing the layer of the service agent 250 enables optimizing bandwidth and throughput while communicating within distributed computer system 100.

(d) The service interface 255 receives service requests. In at least one embodiment, it is a pluggable in-memory interface that abstracts the communication protocol for incoming service requests. Through the abstraction provided by the service interface layer 250, the service runtime environment can be virtually embedded within the memory address of the “real” application service.

(e) The service implementation of synchronization mechanism 230 may be implemented as a composite service. Alternatively, it can also be implemented as an atomic service. The service modules implementing synchronization mechanism 230 as a service have an extroverted nature and can transparently be externalized through standard and/or proprietary protocols.

As illustrated in FIG. 2, application entity 240 communicates with service agent 250 (“Service Invoker” or “Service Requester”) in the case of a create, retrieve, update, and/or delete (CRUD) request. The CRUD request is communicated from a service agent 250 according to the implemented synchronization mechanism 230 to the service interface 255 (“Service Listener” or “Service Receiver”) of the server 210. Here, at server 210, the service interface 255 forwards the CRUD request to the application entity 245 stored at server 210. In response to the forwarded request, the application entity 245 creates a create, update and/or delete notification (notify CUD) to service interface 255. In response, service interface 255 forwards the CUD notification to service agent 250 at client 220 according to the synchronization mechanism 230 and the illustrated network connection. The service agent 250 forwards the CUD notification to the application entity 240 at client 220 which executes after data binding into the user interface component (UI component) at client 220.

Thus, FIG. 2 illustrates that, according to the techniques of example embodiments, the service-based synchronization mechanism can provide the ability to store at clients 220 a copy-application-entity 240, which is a copy of the original application entity 245 stored, for example, within a hierarchical tree of application objects at database server 210. However, any number of copies of application entities, for example application objects 240 stored at clients 220, can be stored at clients 220. In at least one embodiment, the copy-application-objects are further stored in temporary storage at clients 220, for example cache storage. Therefore, in at least one example embodiment, application entity 240 is a copy of the “real” application entity 245 stored at servers 210.

In an exemplary implementation, application entity 245 is a business object of a business application and application entity 240 is a copy of that business object 245 stored at client 220. Via the service implementation represented within service agent 250 and service interface 255, the synchronization mechanism 230 is performed between the “real” application entity 245 and the copy of that application entity 240 being stored at client 220. Thereby, in at least some embodiments, the synchronization mechanism 230 provides a specific service implementation synchronizing any changes performed on copy-application-entity 240 with the stored application entity 245 at server 210.

Thus, a replicated shared object framework is provided that supports, in different application scenarios, the replication of application objects 240/245 between clients 220 and application servers 210 as well as between application servers 130 and database servers 140.

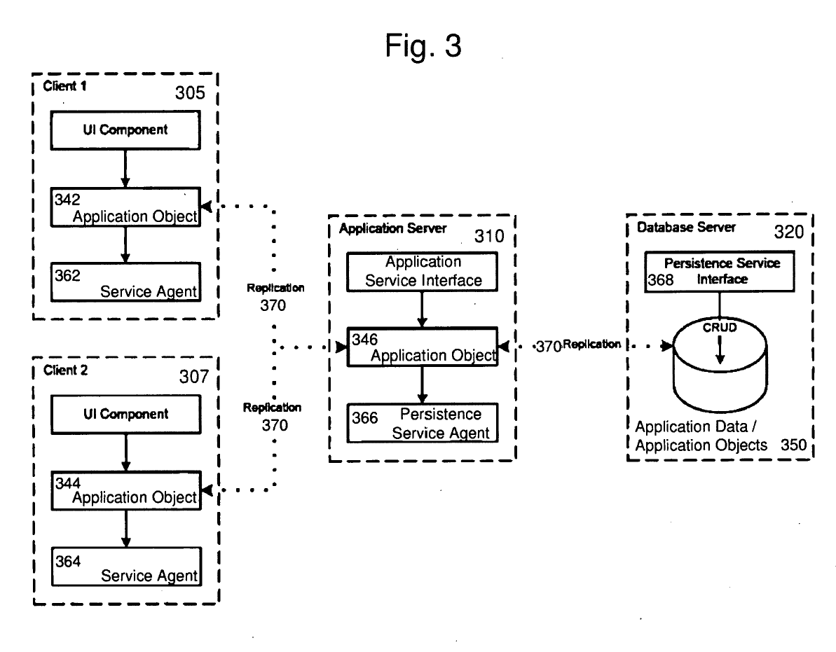

This replicated shared object framework is further illustrated in FIG. 3. FIG. 3 shows clients 305 and 307, which conform to clients 220 and 105-115 as described above. Further, FIG. 3 shows application server 310 and database server 320.

FIG. 3 illustrates the replication mechanism 370 which is performed according to the techniques provided by exemplary embodiments between the different object or respective copies of objects 342-346 stored at clients 305, 307 and servers 310 and the “real” objects 350 stored at database server 320. The number of clients and servers shown serves for illustrative purposes only. In particular, clients 305 and 307 as well as application server 310 might store the “real”, i.e., original object 245. Further, the replication mechanism 370 indicated in FIG. 3 by dotted lines illustrates a logical relationship in terms of the application entities 342-346 being logically connected via the exemplary replication mechanism, rather than illustrating a “technical” connectivity based, for example, on network transaction and protocol elements. Therefore, the communication between the different clients 305, 307 and servers 310, 320 may not realized along the indicated dotted lines of FIG. 3. Rather, in at least one embodiment, the communication is initiated via a service agent 362, 364. In that embodiment, the service implementation components 362-368 are responsible for providing connectivity and transferring protocol messages.

As illustrated in FIG. 3, the replicated shared object framework supports several, i.e., more than one, object store. As illustrated in FIG. 3, objects can be stored at several clients 305 and 307 as well as the application server 310. Furthermore, via the illustrated synchronization or replication mechanism 230, objects 342-346 can be copied between these object stores 305, 307, or 310. However, in at least one embodiment, the copying of a particular object 342 into a new target store 305, 307, or 310 is performed not until a first request on this object 342 is made at the particular target store 305, 307, or 310. Thus, this replicated shared object framework supports a design pattern of lazy loading (sometimes referred to as load on demand) and proxies.

Moreover, changes in the objects or copies of objects 342-346 are synchronized between the different object stores 305, 307, and 310. Notifications of changes performed on objects or copies of objects 342-346 are communicated between the different object stores 305, 307, and 310. In at least one embodiment, a bidirectional transfer of changes between the different object stores 305, 307, and 310 is provided. Furthermore, in at least one embodiment, the service-based implementation of the replication mechanism 230 provides for securing the respective transactions. In particular, changes that are currently performed by different users at clients 305 and 307, and that further are not yet confirmed, are isolated. Furthermore, in at least some embodiments, the techniques ensure that all, or alternatively no meantime (intermediary), changes performed by a user at clients 305, 307 are confirmed and thus published for all other users. In other words, the framework ensures that no partial changes can be confirmed. Moreover, in at least some embodiments, the User Interface(s) support a pattern of “undo” and “redo” within the clients 305 and 307.

In order to achieve this, techniques of example embodiments assume that the data that is to be copied is stored in an application object (e.g., application entity 342-346) as its state, i.e., as the state of the application object. In that respect, it is assumed that every application object comprises a clearly defined and delimited state. In at least some embodiments, the state of an application object is comprehensively described within the application object and the state does not extend into other application objects. This means that the state of an application object is independently described from the context of the respective application object in which this application object is used. The state of the application object, which is described within the object, does not range over several application objects but is solely described with respect to the one respective application object. Moreover, preferably the state of an application object can only be changed via methods of the application objects. Thus, no references into the internal state of objects, except for references to further application objects, are handed to the outside. Based on this premise, application objects can hand solely value types or references to application objects to the outside. Moreover, the entirety of the data that is to be copied is represented via a graph of application objects 350 stored at database server 320. Furthermore, each application object has a unique identifier (ID) which is uniquely defined in place and time.

Therefore, the described replicated shared object framework provides for the extraction of the common functionalities of all general Use Cases with a base implementation. Moreover, the specific functionality for a particular Use Case can be integrated into a unified interface. Thus, the techniques described here provide the advantage of enabling the development of application objects without knowledge about the structure of the implemented synchronization/replication framework, namely the replicated shared object framework.

As illustrated in FIG. 2 and FIG. 3, changes at application objects 342-346 which are performed, for example, at clients 305 and 307 are not performed on original or rather “real” objects 350, but solely on copies of these objects (350 indicating the “real” objects, 342-346 indicating copies of these objects) as described above with reference to the object copy 240 illustrated in FIG. 2. Thus, the described techniques provide for versioned object copies 342-346 which enable the sharing of objects and copies of these objects between different the object stores 305, 307, and 310. Each copy of an object, e.g., each copy-object 342, 344, or 346, contains a unique version number. Application objects can therefore generally not be modified after they have been stored. Thus, in such an example embodiment, an economical mapping of a snapshot of the entire object graph in a defined point in time can be provided. These snapshots create the basis of the versioning concept provided by the described techniques and the support for multi-user operations by user specific modify-views. This snapshot-based versioning concept and support for multi-user operation is further referred to as “snapshot isolation.” According to this versioning concept, only the current version of a particular object can be changed. Any preceding version, i.e., preceding copy version of a particular object, is write-protected. Thus, a shared access and usage mechanism is provided that can be performed on all objects/copy of objects 342-350, while some of the copy versions can be read only, i.e., are write-protected and thus read-only.

In at least some embodiments, version IDs are used for creating the unique version numbers, which can be generated based on distinct and unambiguous and further strictly increasing integer values. These integer values may represent the point in time when a respective version of an application object is stored. This “point in time” of storing, i.e., the event of storing, is called “Commit”. Higher version numbers, because of the monotonically increasing integer values, represent more recent versions of an application object.

Accordingly, a search over the object graph of a defined version can be realized via an SQL-query. For example, a query such as the following could be generated:

SELECT*FROM ResourceTable WHERE Name=’Test%’ AND
(VersionID<=4 AND ValidUntil >=4

In this example embodiment, for efficient access on a specific version of an application object, the storing of the validity area (or scope) is necessary. This scope or area of validity may be defined as follows:

For each application object O, a history of versions Ov1,
Ov2,...is administrated, for which is valid:
vi < vi+1 and Ovi is valid in the time interval [vi, vi+1−1].

Moreover, preferably version numbers can only be assigned by the server in the event of a Commit. The application object version vi means that a specific application object O has been changed at the point in time vi. Therefore, according to this example embodiment, the version numbers for a specific object can have gaps for each point in time vn where the respective object was modified or the modification was not stored.

According to exemplary techniques, the replication of objects is done via object stores. Changes or modifications to application objects are applied initially to specific writable versions of application objects in an associated object store. After the explicit confirmation of the changes, e.g., a “commit”, other object stores are informed about the modifications/changes and are accordingly updated, provided this is desired.

For each client 305, 307, a respective session is provided which uses a private object store. This private object store is initialized with a version of a particular scope, for example, a project which is valid globally. This initialization is done without loading all application objects of the scope or for example, a project in the private object store. Based on the versioned application object references, the later reloading of application object versions, which specifically match exactly to the scope of the version used for the initialization, is ensured.

Furthermore, in at least some embodiments, changes or modifications to application objects can only be applied after checking out these objects. During the checking out of a specific application object, the most current (recent) version of the specific application objects is transferred from the server to the client. This transferred most recent version is noted, in the private object store, as a copy of the previous session version of the application objects. Further, in the process of the check-in, parents and children of new application object version are informed about the new application object version. In response to this notification, these parents and children track, based on application logic, whether or not, as a result of this new application object version, their internal state has been changed. In the case in which parent or child objects note that their internal state has changed based upon the new application object version, the generation of a new application object version is initialized. The changes, as for example, the existence of a new child object or cache invalidation, then are applied to the new application object version.

Furthermore, FIG. 3 shows that the replication of objects 342-346 is typically performed via the object stores 305, 307, and 310. Between the various object stores, for example on clients 305, 307 and application server 310 and database server 320, versioned objects 342-346 are copied and then stored on these object stores. Changes on object/copies of objects 342-350 are initially performed on specific writable versions of objects 342-346 in the associated object stores 305, 307, and 310. Only after an explicit confirmation of these changes, all other object stores at clients 305, 307 and servers 310, 320 are notified about these confirmed changes which then actualizes the respective object/copies of objects.

The synchronization of the changes between the different object stores 305, 307, and 310 is performed via the transfer of transaction protocols. In response to a transfer of such a transaction protocol, comprising a log of the performed changes, these changes are again performed, i.e., the actions noted in the transaction protocol are again executed, on the object/copy of object stored locally at the respective object store. Thus, in at least some embodiments, changes which are performed at one object store, for example, client 305, are logged in a transaction protocol in response to the confirmation of the changes at client 305, and are transferred to the other object stores, at for example, client 307 and servers 320 and 310. In response to receiving this transaction protocol (created as a result of the confirmation of changes at object store 305) at the other object stores 307, 310, and 320, the actions noted in the transaction protocol are again executed on the respective locally stored object 350/copy of the respective objects 344, 346 in order to transform those local object/copy of objects 344, 346 into the same state as the state realized by the confirmed changes at the initial object store 305. In at least one embodiment, on the basis of this concept of versioned object copies 342-350, the action categories to be performed can be reduced to insertion, replacement, and deletion of specific object versions 342-346 into an object graph 350.

Moreover, in at least one embodiment, several changes or modifications of one and the same application object can be captured in only one log entry. In this embodiment, the sequence of the log entries is important for a few cases: for example, during the persisting of changes in a transaction, the sequence of the changes can be important. This is the case, when for example the database checks the reference integrity of, for example, foreign keys. In this case, the transaction log is preferably re-sorted such that a sequence of action is generated which is consistent for the database. Further, checks in the database are not used or can be switched off. Other examples may occur during the execution of the logged changes while performing synchronization. For example, one problem is when an application object is provided with a new child object that is not yet known in the target context and the respective create action is logged afterwards in the transaction log. In this case, all referenced application objects in the transaction log are stored in a transaction object store. This specific object store is additionally used during the commit for the dissolving of object references.

In at least one embodiment, for each application object ID in a transaction log, there is, at maximum, only one log entry: create, update or delete. In this embodiment, it is assumed that a create/delete or update/delete combination is revised such that only the delete entry stays. However, preferably there is no “real” deletion, hence an application object is preferably only “deleted” from the parent collection.

The transparency of the common and replicated use of objects 342-346 for the application code and the application objects 350 as such is therefore achieved by the described combination of a proxy pattern and service implementation.

As illustrated in FIG. 3, all application objects 342-346 are administered by services implemented in components 362-366. Preferably, the application objects 342-346 can only be generated, read, and changed via these services. Therefore, the described techniques support varying and different service implementations which can be defined via configuration at run-time and can also be combined with each other. Thus, location transparency, e.g., between client 305 and/or 307 and servers 310 and/or 320, is provided as well functional transparency in terms of remote versus database services.

More specifically, every application object 342-346 has assigned, via a specific (proxy) service implementation 362-366, a proxy which sits before the “real” object 342-346 (which may be a copy). Thus, an object graph is created that alternates real objects and proxies. Preferably, each proxy references solely real objects. Therefore, real objects again preferably reference solely proxies. Thus, proxies can take over the functions of lazy loading and change tracking from “real” application objects 342-346.

Therefore, the described techniques provide the administration of object references via proxies. In at least one embodiment, a member of the application objects 342-346 is not loaded via the proxies until a request on that particular member of the application objects is performed. In that embodiment, this technique of remote lazy loading is performed for the loading from the database storage as well as for the transfer of objects from servers 310 and 320 to clients 305 and 307. Objects 342-346, which have been loaded into the target contexts 305, 307, and 310 (e.g., the object store, for example, at client 305, 307 or server 310, 320) are stored in a local object store at the respective client 305, 307 or server 310, 320. In at least some embodiments, this local storage is implemented as a local cache. Accordingly, in this embodiment, consecutive reading requests for objects 342-346 which have been loaded before, are serviced from this local cache.

The complete loading of an object graph is thus typically not provided by the described techniques. However, by using local object stores, performance disadvantages typically only occur at the beginning of a session by the reading requests performed. Over time, more and more objects 342-346 have been loaded into the local cache and thus more and more requests can be serviced from the local store. In another embodiment, this performance disadvantage can be compensated for by pre-fetching objects into the local object store. Moreover, in another embodiment, by using specific selection criteria, all objects can be determined ahead and transferred in response to a specific request.

Thus, all writing requests on application objects are re-routed via the proxies such that the proxies can log all changes on application objects 342-346 in a transaction protocol. An entry of that transaction protocol is of the type “modification,” which comprises the actions of create, update and/or delete. Furthermore, an entry in the transaction protocol also comprises a reference to the modified object version.

In order to distinguish writing access from reading access, all reading methods and properties are accordingly labelled or marked. This may be done by a “read only” attribute. Moreover, direct changes or modifications based on respective client accesses are distinguished from internal changes/modifications resulting from indirect changes/modifications. This can be achieved via a flag during a client call on the proxies.

Furthermore, each client 305, 307 is associated with a session independent from whether it is remote or local. This session administers a view on the application object graph that is valid only for the respective client. Thus, in this embodiment, for the application code, the aspect of versioning as well as the multi-user operation is completely transparent. This means that application code can be developed as if all application objects would be used only from one user in only one version.

For achieving this behavior, the concept of a “session” is realized. All objects, which are read via a session from the central application object store, are noted as “copies” in the session-specific application object store. This is done for proxies as well as for real application objects. Typically a section of the object graph is then copied for each client. This means that, in this example embodiment, no application objects are shared between different sessions (they are copied).

Based on using this concept of sessions, a rather simple realization of a session-specific view is provided. Moreover, the option to transparently exchange read-only objects through writable object versions is provided. Further, the references to a parent object can be temporarily stored in an application object without any concern after the initial determination of the session. Finally, this session concept provides for the redundant storing of all read-only application objects which are read by more than one client in their respective client sessions.

In an alternative embodiment, redundant storing could be avoided by using optimization approaches. Specifically, redundant storing could be avoided by sharing the application objects as well as the proxies. Alternatively, in other example embodiments, only the application objects could be shared, while the proxies are generally copied.

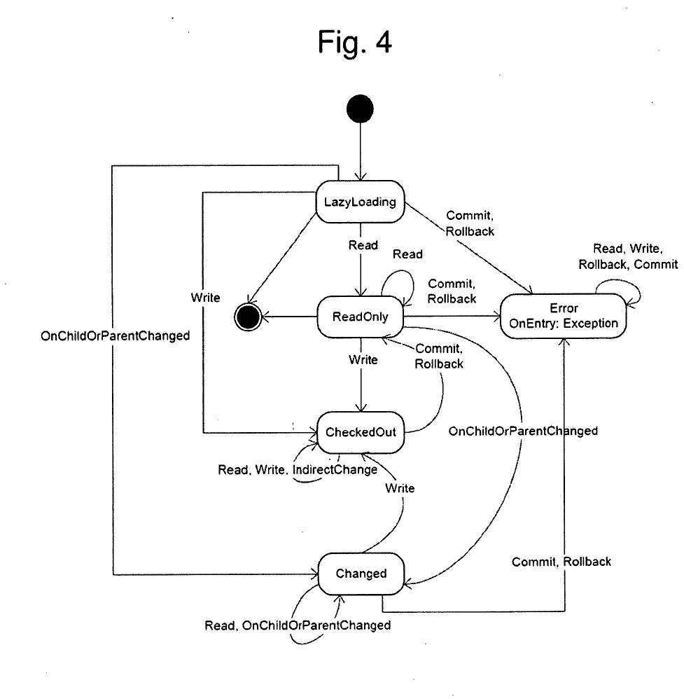

FIG. 4 schematically illustrates the states of proxies during the sequence of a merge routine according to example techniques. The merge algorithm (or routine) is used for importing changed application objects into a target context, e.g., into another object graph. This updating may be executed, for example, during the following actions:

A Transaction Commit (i.e., Check-in): Importing of a locally changed application object into the (database) server context and thus into a globally valid object graph.

Check-out: Importing of the actual, globally valid version of a “to be checked-out” application object into the client context, e.g., into a local object graph.

Updating: Importing of changes of other users/clients into a client context, e.g., into a local object graph.

As shown in FIG. 4, the proxies in a private application object store can adopt four different states: (1) Lazy Loading, the associated application object has not yet been loaded. The proxy only knows the application object ID and the version number of the target application object; (2) Read-only, the associated application object conforms exactly to the version in the global store and therefore, is only allowed to be read; (3) Changed, the associated application object conforms to a private, indirectly changed version (for example, based on a changed sum through a value change of a child object). This application object is only allowed to be read from the outside, this means, that in this state, no direct changes are allowed, and (4) Checked-Out, the associated application object conforms to a not yet confirmed private version.

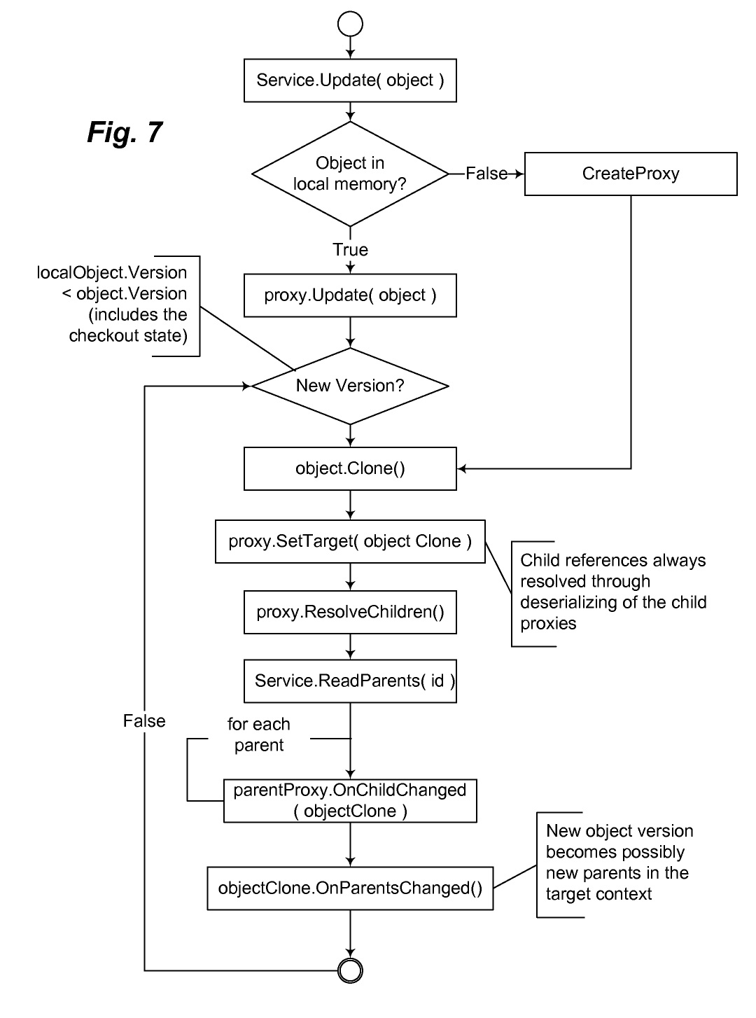

FIG. 7 illustrates a flow diagram that gives an overview of the sequence of actions performed during the merge algorithm according to the techniques of example embodiments.

Based on the states of proxies in private object stores (as described with reference to FIG. 4) and the above-described updating actions, the merge algorithm operates as follows: First, a new application object version is copied into the target context, i.e., the object store of the target context, for example, the private object store of a client 305, 307.

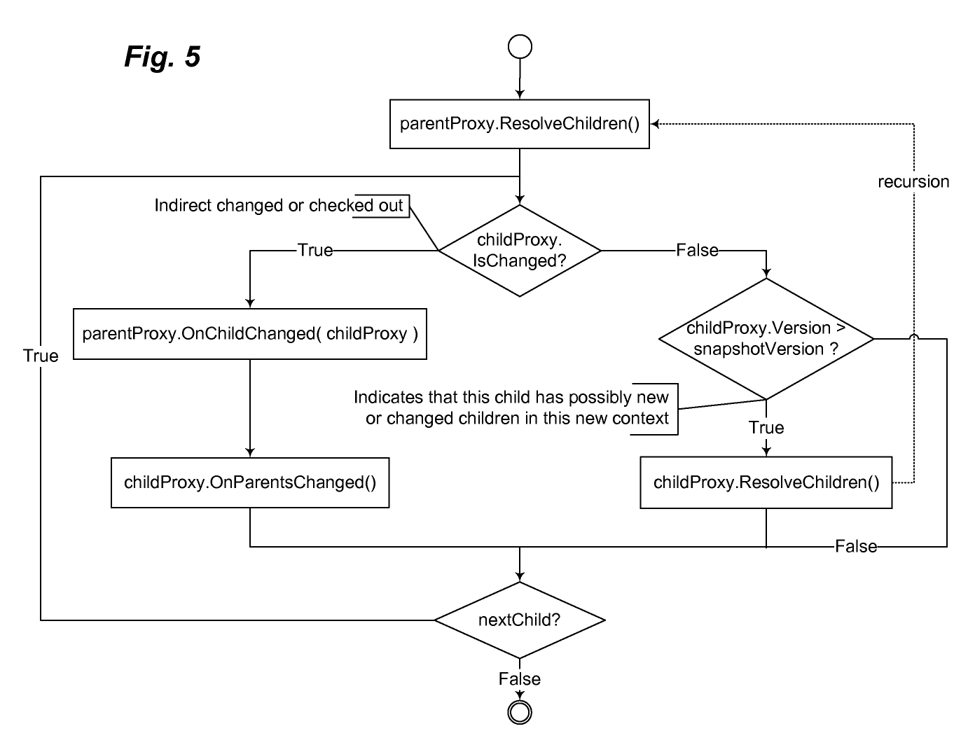

Next, the references to child proxies are “dissolved” within the target context during the de-serializing as follows: initially, a request to the proxy service is issued with the application object ID and version number. This request provides an already existing proxy for this specific object version or a new proxy. Secondly, children generally do not need to be informed about new parent versions, as the child versions that exactly match to the specific parent version are read in. Nevertheless, typically, the merge algorithm checks whether these children are children-of-children (if the new parent version already existed) that have been directly or indirectly changed/modified within the target context. These changed children do not conform anymore to the server state that was the basis for obtaining the state of the (copied) parent version. Furthermore, at least these children and children-of-children are to be informed about the “new” parent version. This check or verification, is preferably executed recursively until all children references with local application objects have been dissolved or until only older objects (objects with a version number lower or equal to snapshot version) are found. Below the dissolved object references which are older or equal to the snapshot version according to the above-described versioning concept, no locally changed objects can exist as these already would have informed their respective parents about these changes and therefore, these parents would have been loaded into the target context. This dissolving of the child references in the new target context can be accomplished based on the method “Resolve Children,” which is illustrated in FIG. 5.

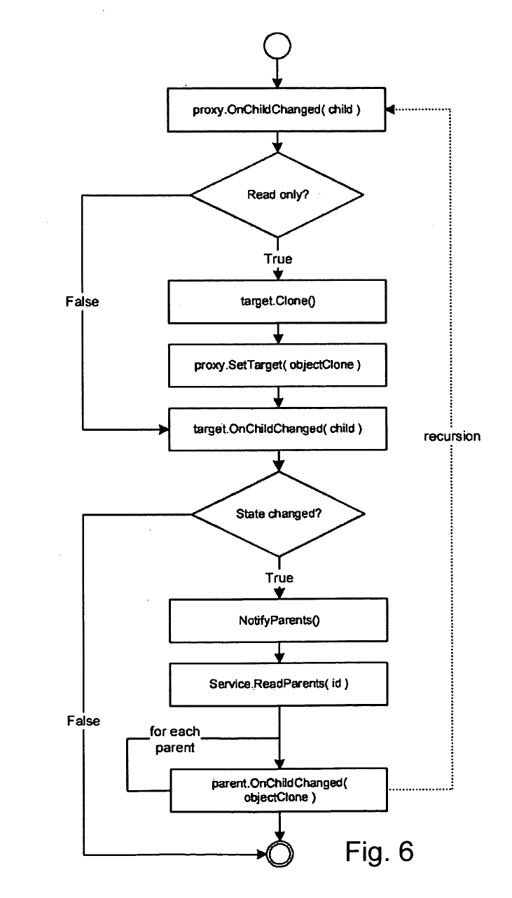

Then, parents are informed about new child versions using the following logic. Initially, a request is issued to the proxy service to provide information regarding the parents of the new object version, based on the application object ID. These parents may not conform anymore to the parent of this specific object version on the server. These parent objects are then informed about the new child version based on invoking the “OnChildChanged” method. An intermediary proxy reacts depending on its state of either read-only or changed/checked-out. An example flow diagram illustrating in more detail the sequence performed upon calling “OnChildChanged” is further described with reference to FIG. 6. In the case of a “read-only” state, the proxy generates writable copies of the parent objects and forwards the call of “OnChildChanged” to these copies. In the case of a “changed/checked-out” state, the proxy forwards the call to the target object which, in response, discards its cache and again, informs its parents about the changes via the calling of “OnChildChanged”. Thus, all parent paths are run through to the ancestral root.

Based on this merge algorithm, globally valid parent relationships are ignored in favour of the locally known parent relationships of the new application object version. (Local relationships are given preference.) This means that, in this example embodiment, consciously, an inconsistent view is accepted in order to fulfil the requirement of the user to only update a section, i.e., an object, of the user's view. Nevertheless, the update of the children of the new application object's version is in contrast enforced, since these are part of the changed state of the new object version.

This technique minimizes the need for central synchronization, reducing bandwidth and system resources consumed for synchronization/replication and therefore, increases system performance and scalability. In particular, this minimizing of central synchronization is achieved by easing or loosening the requirements for the consistency of client and server views. However, in spite of these loosened requirements, this technique, in particular the herein described merge algorithm, ensures that at any point in time a consistent server view can be generated that integrates all local changes at all clients, e.g., stores all local changes into a consistent server view.

Preferably, updating of the parent relationships on a merge can be optionally configured since this behavior is not required by the techniques, but, rather, stems from specific user preferences. Other options are preferably configurable, too. For example, it may be desirable to configure whether a commit of a single object is supported or not. In the case that the commit of the single object is configured to be not supported, only the commit of the complete actual transaction and, thereby, the commit of all “not yet confirmed” changes of a context is supported. This would, for example, be desirable in the case when a project is stored. Further, it may be preferably configurable whether after a commit, the snapshot of the client is completely updated based upon the confirmed version of the server. Other things are configurable as well.

The merge algorithm described ensures that changes or modifications on application objects can be replicated without any conflicts. This enables high performance when processing transactions. In particular, this technique is applicable for graphs of application objects where the application objects have dependencies amongst each other, such that changes or modifications on one application object initiates further changes on depending application objects. According to the above-described technique, as a sole source of error, the emergence of cycles in the object graph during the commit event is to be checked. However, this conflict is not specific to replication mechanisms, but instead has to be generally checked within distributed computer application systems as described herein.

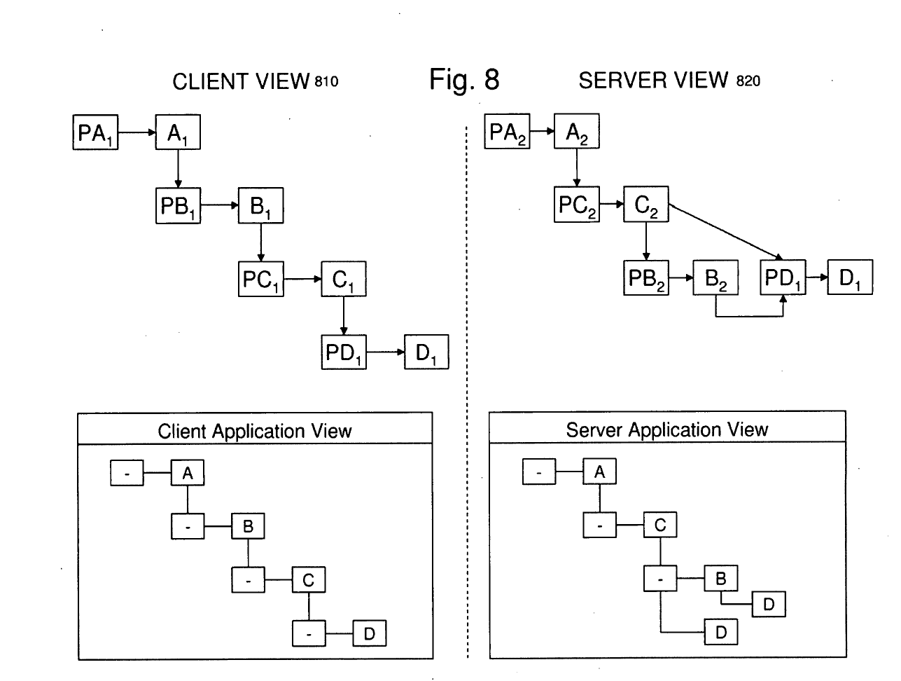

FIGS. 8 to 12 highlight examples of a sequence of changing and updating actions according to the above-described merge algorithm. In particular, FIGS. 8 to 12 each show a client view and a server view of the application object graph. In each of the client and server views, the “internal” object graph structure comprising object proxies and objects is illustrated as well as the application view. In the application view, the user interface of the application on the client as well as on the server side shows only object representations. The abbreviations “PA1” in FIGS. 8 to 12 denominates the proxy object “PA” for object “A” in version “1”. Furthermore, in each of the FIGS. 8 to 12, in the applications views either on the server or client side, objects are indicated by their name as the question of proxy and version needs not be made apparent from the user interface.

Moreover, in FIGS. 8 to 12, in the client as well as the server view, the hierarchical structure of proxy objects and respective objects (i.e., object versions) are indicated by arrows. The arrows illustrate the hierarchical structure of the object versions. Within the application (e.g., the graphical user interface views of the client and server), the objects are illustrated as a hierarchical graph of objects that can be collapsed and expanded.

For example, in FIG. 8, on the left-hand side, the client view of the hierarchical proxy objects/application object structure is illustrated. The upper section on the left-hand side of FIG. 8 illustrates the internal object representation of the object structure (e.g., the object graph) that is displayed in the application view of the client using the graphical user interface indicated in the lower left-hand section of FIG. 8. The client view 810 of FIG. 8 is based upon the original initial state indicated by the version numbers “1” of the illustrated proxies and application objects. On the right-hand side of FIG. 8, the object representation stored at the server shows that, at the server, some changes have been confirmed (committed) indicated by the version number “2” of the illustrated proxies and application objects in the server view 820. In particular, the following changes have been confirmed on the server side: the object “C” has been moved under the object “A” and the object “B” has been moved under the object “C”.

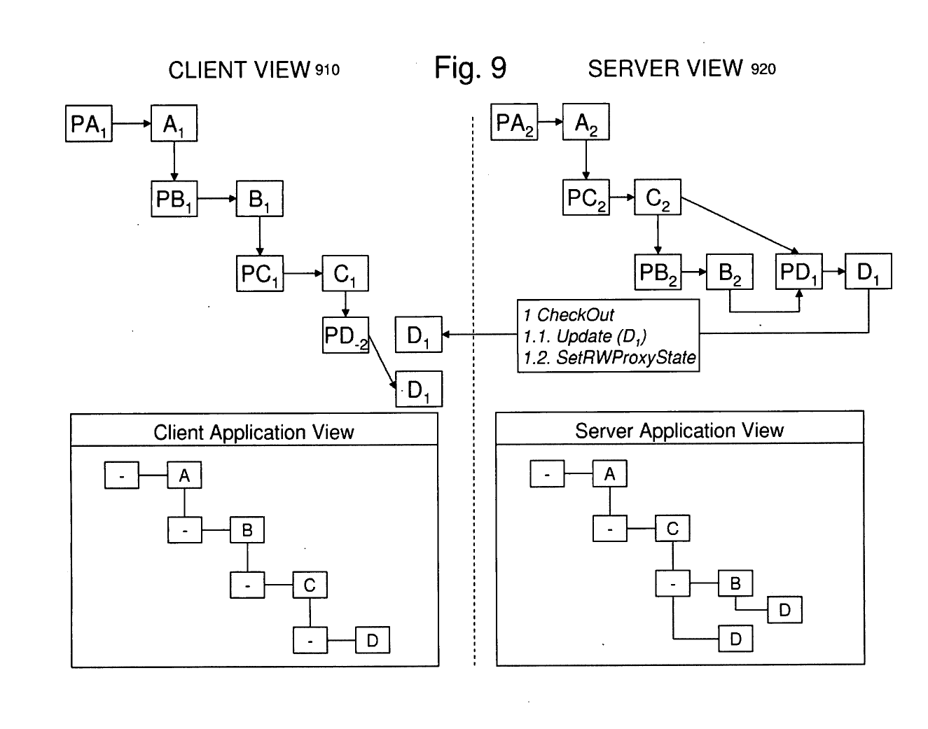

FIGS. 9-12 further illustrate what happens in the client and the server view when the client (e.g., a user) checks out object “D” in order to change/modify object “D” and then performs an update of object “C2” to update the client view of object “C1” to a later version.

According to the merge algorithm illustrated in FIGS. 4 to 7, the following calling sequence is performed: in order to check out object “D,” the method Service.Update (D1) is called (e.g., invoked), which causes, the method PD1.Update (D1) to be called. In response, the method PD1.ChangeState (check-out) is called (not shown). In that method, the object D in version 1, i.e., “D1,” is copied and the state of the respective proxy PD1 is set to “checked-out” (shown as PD-1). These changes, i.e., the calling of the update method, the copy of D1, and the changing of the proxy state to “checked-out” are demonstrated in FIG. 9.

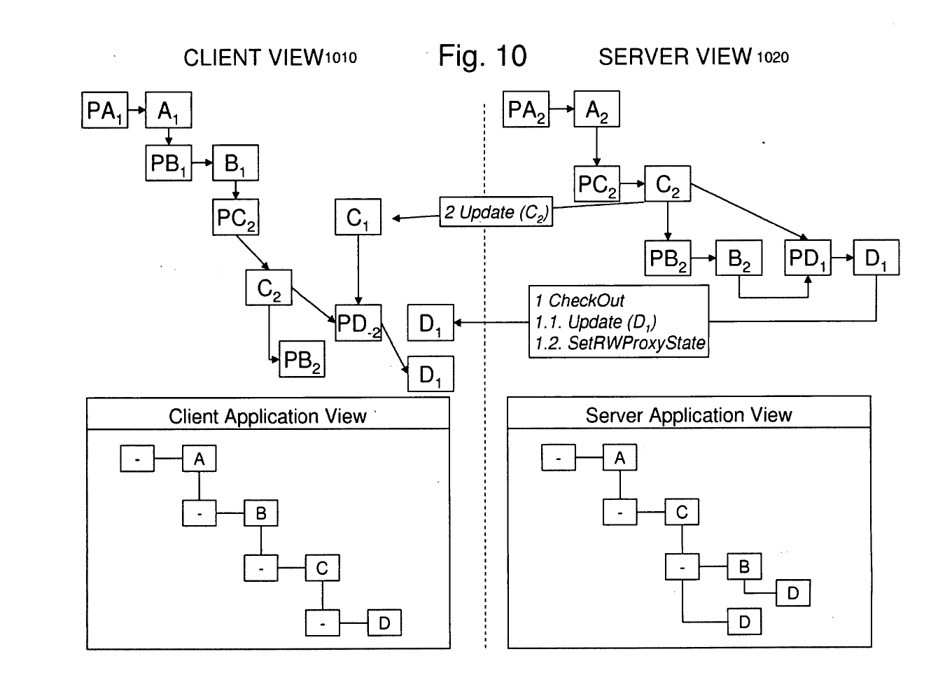

Sometime subsequent to these calls, it is desired to update the client's “C” object to the most recent object on the server. Accordingly, the method Service.Update (C2) is called. Next, the respective proxy is updated by calling the method PC1.Update (C2). As a result, the method C1.Clone ( ) is called because the version on the client is older than the server. Next, the method PC1.SetTarget (C2) is called to set the proxy to the newer version of the object (the clone). After the performance of this sequence of calls, the temporary state illustrated in FIG. 10 has been created. In this temporary state, the local object C2 (object C in version 2), points now to the local object D1, (the object D in version 1) as well as to the lazy load proxy PB2.

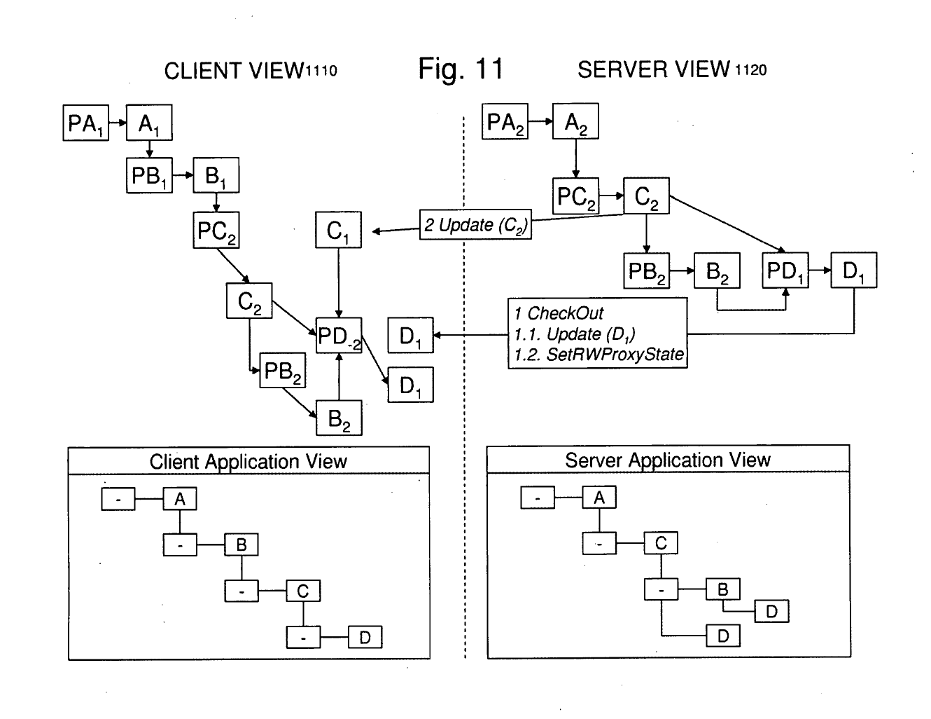

After setting the state of the proxy object D2 to “checked-out” and updating the object C to C2, as illustrated in FIGS. 9 and 10, the child relationships are checked. In particular, the method PC2.ResolveChildren ( ) is called. The proxy of object B in version 2 (i.e., PB2) as the first child is checked. In this example, it is determined that nothing has been modified locally on this child object, but it is determined that the object version of the object B, in particular object B2 on the server, is a newer version than in the snapshot stored on the client, which is still the object B version 1 (i.e., object B1). Thus, in response to this determination, the method PB2.ResolveChildren ( ) is called. Based on this method, the proxy of object B in version 2 (i.e., PB2) reads its respective target object B in version 2 (i.e., object B2) from the server and when doing this, makes note on the client that child D1 has been checked out and that object B2 has not yet been changed. Thus, in this example, it is determined that the version of object D stored at the server, in particular object D1, is not newer than the version that is valid in the snapshot stored on the client (object D1). The object graph resulting from these calls is illustrated in FIG. 11.

As a result of this state (updating C2 children), as illustrated in FIG. 11, the method Service.ReadParents (C2.ID) is called to obtain information on the parents of object C2 (on the client snapshot, which may be out of date). Here, it can be seen that there is a single parent, object B1. Accordingly, the method PB1.OnChildChanged (C2) is called. In this call, the sequence of: (1) B1.Clone ( ), (2) PB1.SetTarget (B1), (3) B1.OnChildChanged (C2), (4) B1.NotifyParents ( ), (5) Service.ReadParents (B1.ID), and (6) PA1.OnChildChanged (B1) are initiated. Similarly, as a recursive sequence, by calling PA1.OnChildChanged (B1), the sequence of: (1) A1.Clone ( ), (2) PA1.SetTarget (A1), (3) A1.OnChildChanged (B1), and (4) A1.NotifyParents ( ) are initiated.

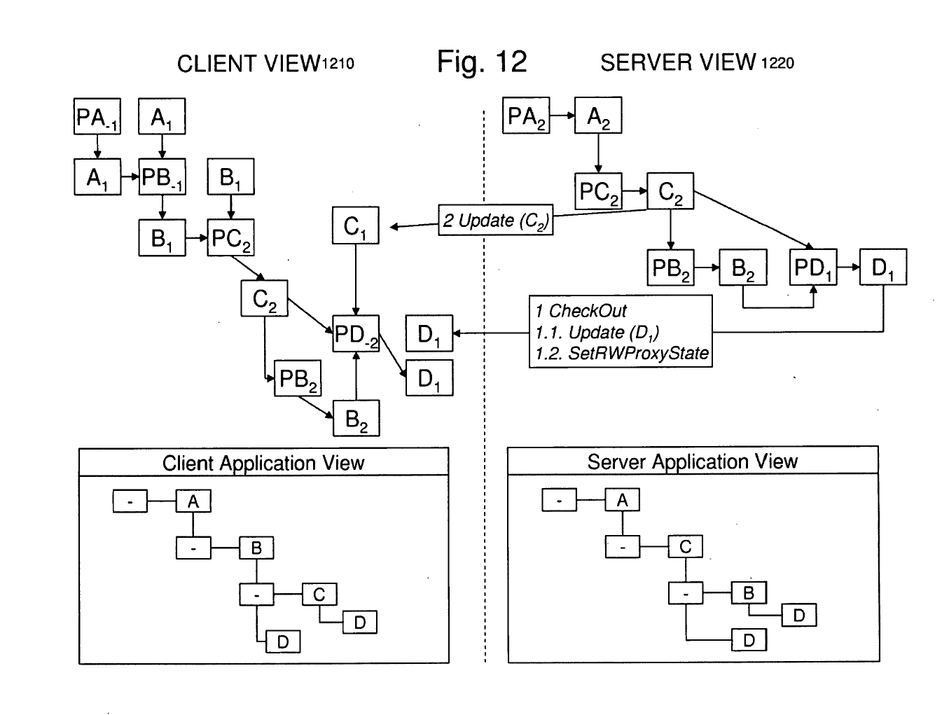

After having performed the checks on changes of the child objects as described in the above sequences, changes concerning parent objects are checked by calling the method C2.OnParentsChanged ( ). In this case, object C in version 2 (i.e., object C2) has values which depend from the parent object B1, and the temporary store, i.e., the cache of these values, will be declared invalid and again, the child objects and parent objects will be informed. The state that emerges from executing the above sequences is further illustrated in FIG. 12.

FIG. 12 illustrates that, by using the described merged algorithm, the application object proxies can change their internal state in a transparent way into the most current version. To the client code, for example, the user interface illustrated in the client application view in FIG. 12, it seems that the interaction happens on one and the same object. However, the state of that object can change over time.

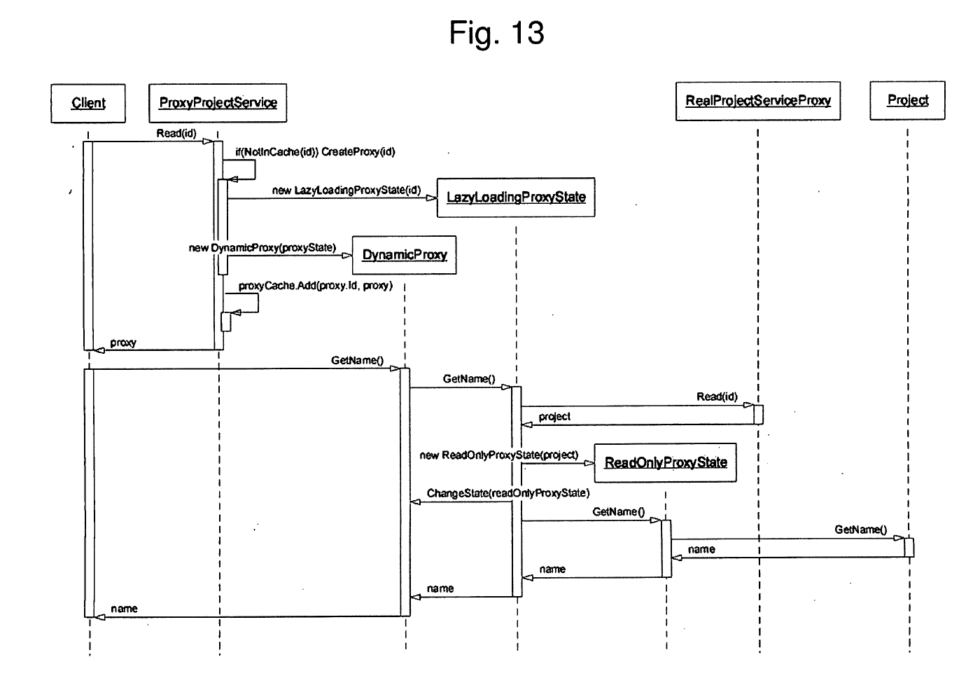

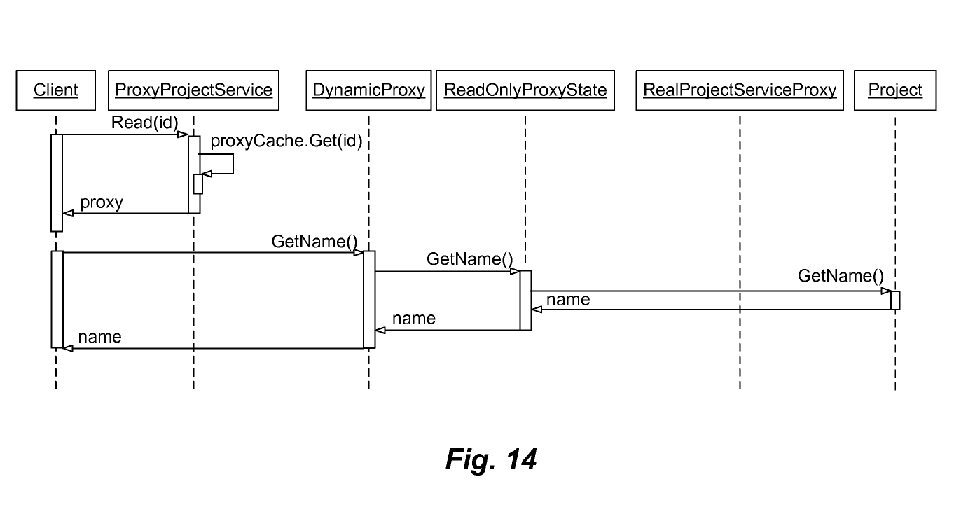

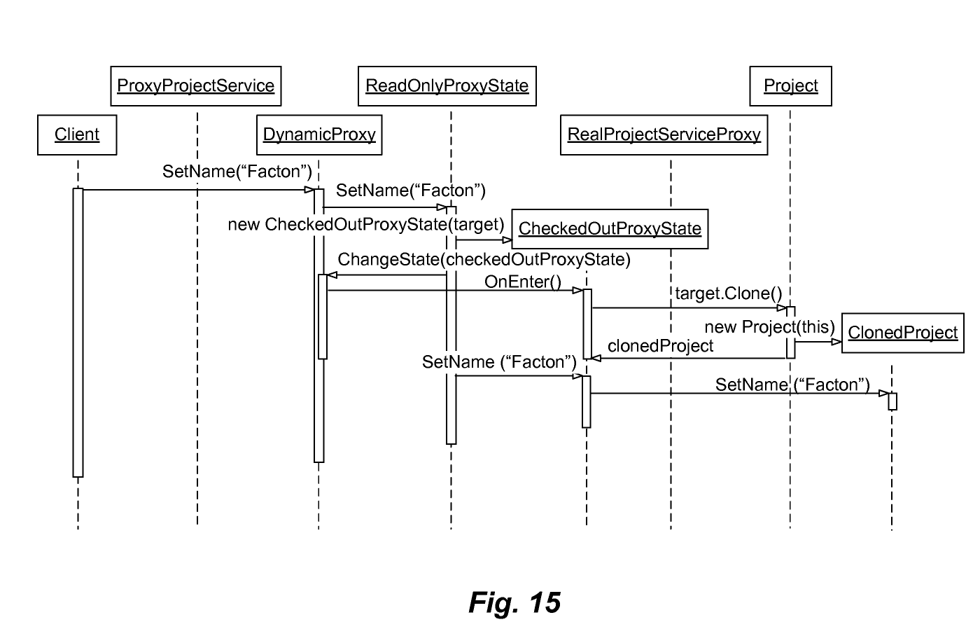

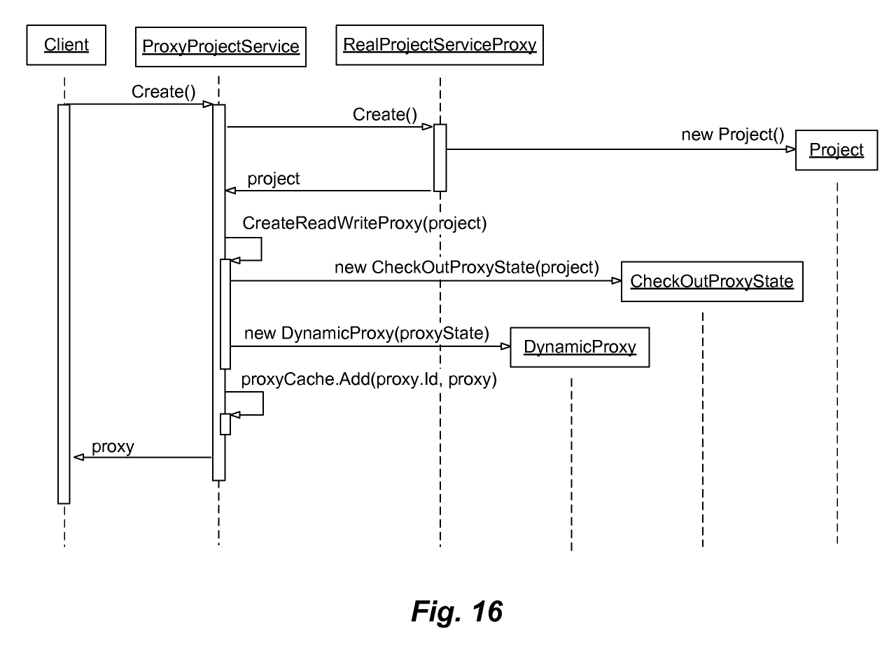

FIGS. 13-16 show example sequence diagrams illustrating the procedures performed to create proxies. In particular, FIG. 13 shows the Lazy Loading sequence. FIG. 14 further highlights the sequence performed for a Read operation. FIG. 15 shows the sequence performed for a Write sequence, and FIG. 16 shows the Create sequence. These sequence diagrams show the calls of respective methods that are directed to application objects, but which are instead satisfied via Proxy Services. In particular, the sequence diagrams show that all object references are requested via an object service. Via dependency injection, a proxy service is inserted before the actual object service.

As shown in FIGS. 13-16, an automated relationship-management is realized between the application objects while performing the replication mechanism. This is achieved via a combination of proxies and respective services. In particular, in the case that two different application objects A and B point to one and the same application Object C, then also the replicated objects A′ and B′, after performing the replication, point to the also replicated object C′. Moreover, changes to an application object can automatically initiate subsequent changes to other application objects. This propagation of changes is accounted for in the replicated shared object framework. Preferably only the causal changes are transmitted into the target store during the replication. By performing replay on the target store, the subsequent changes that are valid in the target store are generated at the target store. This enhanced technique is realized by transparently integrating application logic and the replication mechanism. This integration is achieved by using the patterns of proxy, service and dependency injection.

Dependency injection refers to the process of supplying an external dependency to the software component. It provides a specific form of in version of control where the concern being inverted is the process of obtaining the needed dependency. Conventionally, if an object needs to gain access to a particular service, the object takes responsibility to get hold of that service. Either the object holds a direct reference to the location of that service or it goes to a known service locator and requests to be passed back a reference to an implementation of the specific type of service. By using dependency injection, however, the object simply provides a property that can hold a reference to that type of service, and when the object is created, a reference to an implementation of that type of service will automatically be injected into that property by an external mechanism. This approach provides for increased flexibility in creating alternative implementations/applications using the provided synchronization/replication framework. As the synchronization/replication mechanisms are implemented as services, the flexibility to make use of these services in varying implementations/application increases since the specific implementation that is to be used can be declared via a configuration file at run-time—without any change to the application objects that use the services. Thus, the application objects (or the database application) can be developed without any specific knowledge as to the structure and implementation of the presented synchronization/replication mechanisms.

Thus, by using dependency injection, the proxy service instead of the requested application objects 342-346 creates proxy objects. The proxy objects can then later request via the real object service the actual application objects 342-346 and re-route all requests to them.

All of the above U.S. patents, U.S. patent application publications, U.S. patent applications, foreign patents, foreign patent applications and non-patent publications referred to in this specification and/or listed in the Application Data Sheet are incorporated herein by reference, in their entirety.

From the foregoing it will be appreciated that, although specific embodiments have been described herein for purposes of illustration, various modifications may be made without deviating from the spirit and scope of the present disclosure. For example, the methods, techniques, computer-readable media, and systems for providing a replicated shared object framework discussed herein are applicable to other architectures other than a database architecture. Also, the methods, techniques, computer program products, and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.).

1. A computer-implemented method of isolated shared object replication of application objects of a database application in a distributed computer environment wherein application objects are replicated from a server computing system (“server”) to at least one client computing system (“client”) of a plurality of client computing systems in the distributed computer environment, the method comprising:
providing an application object service that handles requests issued at the at least one client;
providing a proxy application object service and inserting the provided proxy application object service before the application object service;
generating, using the proxy application object service, one or more proxy application objects, each proxy application object assigned to an original application object that is stored in a database of the database application;
re-routing a database request issued at the at least one client that is directed to at least one original application object via the proxy application object assigned to the at least one original application object, the proxy application object directing and tracking all changes intended for the at least one original application object instead to a replicated application object that corresponds to the at least one original application object; and
causing a merging process to be executed that either imports changes from the database into a context of the client or that exports changes made to the replicated application object on the client to be integrated into the at least one original application object of the database, wherein the merging process is based on loosened requirements regarding the consistency of client and server views, such that at least two clients have different views of the context of the same original application object at the time the merging is initiated.

2. The method of claim 1 wherein the causing the merging process to be executed comprises:
causing a merging process to be executed as part of a commit operation, the merging being executed in order to export changes made on the client to the replicated application object that corresponds to the at least one original application object to integrate the changes into the at least one original application object of the database, wherein the merging is based on loosened requirements regarding the consistency of client and server views, such that at least two clients have different views of the same original application object at the time merging is initiated.

3. The method of claim 1 wherein the causing the merging process to be executed comprises:
causing a merging process to be executed as part of a check-out or an update operation, the merging being executed in order to import changes made to the at least one original application object by at least one other client of the plurality of client computing systems into the replicated application object on the client before the database request issued at the at least one client is completed, wherein the merging is based on loosened requirements regarding the consistency of client and server views, such that at least two clients have different views of the same original application object at the time merging is initiated.

4. The method of claim 1, further comprising:
retrieving, not before a request is made on data of the at least one original application object by the proxy application object via the application object service, the at least one original application object from the database; and
replicating the retrieved at least one original application object on the client as the replicated application object.

5. The method of claim 4, further comprising:
storing the replicated application object copy at the client in a local cache; and
servicing, via the replicated application object from the local cache, all requests on the client directed to the original application object.

6. The method of claim 1 wherein each proxy application object references solely original application objects and original application objects reference solely proxy application objects.

7. The method of claim 1, further comprising:
providing a unique version number for each replicated application object; and
changing the version number of a replicated application object in response to a change in state of the replicated application object.

8. The method of claim 7, the proxy application object directing and tracking all changes intended for the at least one original application object instead to the replicated application object further comprising:
logging all changes applied to the replicated application object in a transaction protocol, the transaction protocol including a reference to a modified version of the replicated application object.

9. The method of claim 8 wherein the changes applied to the replicated application object are at least one of insertion, replacement or deletion of a version of the replicated application object in an object graph.

10. The method of claim 9 wherein the object graph comprises alternating proxy application objects and application objects.

11. The method of claim 1, the loosened requirements regarding the consistency of client and server views requiring that replicated copies of children application objects that are children of replicated application objects to be merged are consistent across all of the plurality of client computing systems whereas replicated copies of parent application objects that are parents of the replication application objects about to be merged may retain local client changes.

12. The method of claim 1, the merging causing updates to occur on a plurality of other ones of the plurality of client computing systems.

13. A computer-readable medium having stored thereon computer-readable instructions that, when executed on a computer, are configured to perform a method comprising:
providing a proxy application object service and inserting the provided proxy application object service before an application object service that handles requests for access to application objects;
generating, using the proxy application object service, one or more proxy application objects, at least one proxy application object assigned to an original application object that is stored in a database of a database application;
routing a request that is directed to the at least one original application object instead to the proxy application object assigned to the at least one original application object, the proxy application object causing a replicated application object that corresponds to the original application object to be created using data transferred from the database and logging all changes intended for the at least one original application object instead to the replicated application object; and
causing merging of changes made to one or more replicated application objects associated with the at least one original application object on other ones of the plurality of client computing systems with the logged changes made to the replicated application object on the client, wherein the merging is based on loosened requirements regarding the consistency of client and server views, such that at least two client computing systems have different views relating to the same original application object at the time the merging is initiated.

14. The computer-readable medium of claim 13, the merging causing an update of one or more objects on the client.

15. The computer-readable medium of claim 13, the merging causing an update to the original application object on the server from the logged changes to the replicated application object on the client.

16. The computer-readable medium of claim 13, the logging all changes intended for the at least one original application object instead to the replicated application object further comprising:
logging all changes to the replicated application object in a protocol that can be replayed on one or more replicated application objects associated with the at least one original application object on other ones of the plurality of client computing systems.

17. The computer-readable medium of claim 13, the method further comprising:
generating an object graph containing a proxy application objects and corresponding replicated application objects.

18. The computer-readable medium of claim 13 wherein changes to the original application object comprise generating changes to the object graph.

19. A distributed computer system configured for isolated shared object replication of shared application objects of a database application, the computer system executing a database application that replicates shared application objects between a plurality of clients and servers of the distributed computer system, wherein application objects are replicated from a server to at least one client of the plurality of clients and an application object is not transferred from the server to the client for replication until at least a request on the data of the application object is generated at the client, the distributed computer system comprising:
an application object service configured, when invoked, to handle all requests issued at the least one client;
a proxy application object service configured, when invoked, to
generate on the at least one client at least one proxy application object assigned to an original application object that is stored in a database of the database application; and
route and track requests made at the at least one client on the original application object instead to a replicated copy of the original application object transmitted from the database application;
an injection mechanism that is configured, when executed, to insert the proxy application object service before the application object service on the at least one client, such that the proxy application object service is automatically invoked to handle all requests issued at the least one client; and
a merge mechanism that is configured, when executed, to integrate changes made by the proxy application object service to context relating to the replicated copy of the original application object on the at least one client with context relating to other replicated copies of objects of the original application object on other of the plurality of clients, wherein the integration is based on loosened requirements to the consistency between client and server views, such that at least two clients have views of object context relating to the original application object that differ when the merge mechanism is initiated.

20. The system of claim 19, the loosened requirements also such that at least two clients have views of object context associated with the original application object that differ after the merge mechanism has integrated all of the changes made to the original application object.

21. The system of claim 19, the merge mechanism configured, when executed, to cause an update of the original application object on the server.

22. The system of claim 19, the merge mechanism configured, when executed, to cause an update of the replicated application object on the client.

23. The system of claim 19, the loosened requirements such that all application objects that are children of the original application object on the at least one client are updated to a most recent server view after the merge mechanism has integrated all of the changes made to the original application object.

24. The system of claim 23, the loosened requirements such that at least some application objects that are parents of the objects associated with the original application object on the at least one client are different from a most recent server view after the merge mechanism has integrated all of the changes made to the original application object.

25. The system of claim 19, the proxy application object service further configured to use an object graph to make changes to the replicated application object.

26. The system of claim 25 wherein the changes comprise at least one of insertion, replacement or deletion of a version of the replicated application object in the object graph.
